(19) United States
(12) Patent Application Publication
(10) Pub. No.: US 2026/0231307 A1
(43) Pub. Date: Aug. 6, 2026

(54) LED DRIVING ARRANGEMENT

(71) Applicant: SIGNIFY HOLDING B.V., Eindhoven (NL)

(72) Inventors: JIE FU, SHANGHAI (CN); ZHIQUAN CHEN, SHANGHAI (CN); GANG WANG, SHANGHAI (CN)

(21) Appl. No.: 19/156,503

(22) PCT Filed: Feb. 7, 2024
(86) PCT No.: PCT/EP2024/053074

§ 371 Date: Aug. 14, 2025

(30) Foreign Application Priority Data
Feb. 15, 2023 (WO) PCT/CN2023/076258
May 17, 2023 (EP) 23173961.6

(51) Int. Cl. H05B 45/3725

(52) U.S. Cl. CPC H05B 45/3725

(57) ABSTRACT

An LED lighting circuit. A converting circuitry connects between a first LED load and a second LED load, and controls the power flow through the second LED load by converting a power flow through the first LED load and applying the converted power to the second LED load. The first LED load and the second LED load are connected in parallel and a bus voltage is above the forward voltage of first LED load but below the forward voltage of second LED load.

### FIELD OF THE INVENTION

The present invention relates to the field of lighting, particularly to driving arrangements for use in luminaires.

### BACKGROUND OF THE INVENTION

The increasing use of artificial light is causing a greater demand for lamps, such as lamps or lightbulbs. In particular, there is a growing demand for compact and power efficient, which can be mass manufactured using reduced material resource. It is typical for a lamp to comprise a plurality of light emitted diodes (LEDs) and an LED driving arrangement to drive or power the LEDs.

Due to its relatively high efficiency, such an LED driving arrangement typically comprises a switched-mode power supply (SMPS). However, whilst an SMPS has an extremely high efficiency, it has a relatively large size and cost. There are a number of applications for which a more compact LED driving arrangement would be advantageous (e.g., for use in small-scale lamps, such as those used for automobile interiors or illuminating the interior of household appliances). The size and the cost of the switched-mode power supply are usually positively co-related with the power of the switched-mode power supply: the higher the power, the larger the size and cost.

One possible alternative to an SMPS, for use in an LED driving arrangement, is a linear circuit or linear power supply. Linear circuits are advantageous for having a simple circuit design (requiring no switches) and have a relatively small size and/or material cost. This increase ease of manufacture. However, a downside of existing linear circuits is that they usually have a relatively low efficiency.

There is therefore a desire to provide an LED driving arrangement with increased efficiency whilst remaining compact in size.

EP3099139A1 discloses a topology wherein a LED 20 is in series with a switching converter circuit 44 between a bus voltage VR, and another LED 22 is powered by the switching converter circuit.

### SUMMARY OF THE INVENTION

The invention is defined by the claims.

The proposed invention overcomes the above-mentioned problems by providing an LED lighting circuit that is able to adapt to different power conditions. In particular, nowadays the LED lighting circuit often contains two or more LED loads for implementing light mixing of multiple color temperatures or multiple colors. Due to the variance of the LED loads, or the different driving scheme to the LED loads, the LED loads are not driven in the exact same manner and there is some variance between the power to the LED loads. The application proposes that the headroom in driving one LED load can be at least partially converted and further used to drive another LED load or used as the headroom in driving said another LED load. In this way, the headroom of one LED load is not fully dissipated in a passive and power lossy way, but is utilized in an active way. To implement this, the application proposes a converting circuitry that is connected between two LED loads is used to control the power flow through one of the LED loads using power provided to the other LED load.

In particular, it is recognized that large voltage gap between an output voltage of a primary power supply (for LED loads) and the forward voltage of the LED loads introduce a large loss in the overall LED lighting circuit if such voltage gap is handled by a linear circuit.

The proposed system makes uses of this significant voltage gap (which is much larger than a forward voltage of any single LED load) in an actively switched manner to provide energy to other nearby LED string without dissipating the significant voltage tap by a linear switch. Thus, previously wasted energy is repurposed to power at least some of the other LED loads.

The described system can thereby improve the efficiency of the LED lighting circuit, and at same time increase the conduction time of the additionally powered LED loads and increase LED utilization.

The above principle is especially used for parallel LED strings, and even more especially used for a bus voltage above the forward voltage of one LED string but below the forward voltage of another LED string. Thus the power loss in driving parallel LED strings is reduced.

According to examples in accordance with an aspect of the invention, there is provided a LED lighting circuit comprising a primary power supply configured to output a primary output power on a bus such that the bus carries a bus voltage; a first LED load connected to the bus and with a forward voltage less than the bus voltage; a second LED load connected to the bus and with a forward voltage higher than the bus voltage; characterized in that the LED driving arrangement further comprises a converting circuit comprising: an input, wherein the first LED load and the input are connected in series across the bus; an output, wherein the second LED load and the output are connected in series across the bus, wherein a series connection of the second LED load and the output is in parallel with the series connection of the first LED load and the input; and a power conversion circuit connected between the input and the output and adapted to: receive, at the input, a power flowing through the first LED load; convert the power; and route the converted power to the second LED load, via the output, to control the power flowing through the second LED load.

The proposed approach allows for control over the power provided through a second LED load using power that was previously passed through a first LED load. Approaches therefore allow for redistribution of power to drive a second LED load for improved efficiency, consistency and LED load utilization.

The power conversion circuit may be adapted to: convert an input voltage received at the input into an output voltage at the output; and control the output voltage at the output, which output voltage is applied in a forward bias direction of the second LED load so as to be superimposed with the power provided by the bus to the second LED load and regulate a power flowing through the second LED load.

This embodiment is suitable for injecting extra voltage into the second LED load and drive it. This can mitigate requirement on the amplitude of the bus voltage so the bus voltage does not need to be excessively high which may cause more power loss at the first LED load.

The power conversion circuit may be adapted to control the input voltage at the input of the power conversion circuit, which input voltage is applied in a reverse bias direction of the first LED load and adapted to counteract with the power provided by the bus to the first LED load, so as to regulate a power flowing through the first LED load.

This approach allows for control over the voltage across the first LED load in order to regulate the power flow through the first LED load. This can ensure more consistent and uniform operation of the LED lighting circuit (e.g., more consistent output of light by the first LED load), the headroom for driving the first LED load is also provided.

The power conversion circuit may be adapted to control, via the input, the voltage drop across the first LED load, being a difference from the bus voltage to the input voltage. This allows for regulation of the power flow through the first LED load for improved consistency of light output by the first LED load.

The power conversion circuit may be adapted to control, via the input, a first residual voltage, being a difference between the bus voltage and the voltage at the input, to approach the forward voltage of the first LED load, and control, via the output, a second residual voltage, including the voltage at the output, to approach the forward voltage of the second LED load.

Since the residual voltage actively adjusted by the power conversion circuit approaches the forward voltage of the LED load, the power loss for driving the LED load is decreased.

In some examples, the LED lighting circuit further comprises a first linear current source connected between the first LED load, the input and the bus and with a first minimum voltage headroom, and a second linear current source connected between the second LED load, the output and the bus and with a second minimum voltage headroom.

In this example, the power conversion circuit can be implemented as a voltage regulator, and using a linear current source to control the current in a relatively easier way. Alternatively, the power conversion circuit can be implemented as a current regulator and the extra current source can be saved.

The power conversion circuit may be configured to control the voltage at the input such that a first voltage difference, between the first residual voltage and the forward voltage of the first LED load, is applied on the first linear current source and is no less than but as close as possible to the first minimum voltage headroom; and control the voltage at the output such that a second voltage difference, between the second residual voltage and the forward voltage of the second LED load, is applied on the second linear current source and is no less than but as close as possible to the first minimum voltage headroom.

Providing a voltage difference higher than minimum headroom across a linear current source can ensure the linear current source operate stably in linear mode to regulate the desired current.

The converting circuit may comprise an inverting circuit adapted to: invert the polarity of power received at the input of the converting circuit to provide an inverted signal; and apply the inverted signal, via the output, to the second LED load, in the forward bias direction, so as to increase the voltage difference across the second LED load. This technique allow for the voltage across the second LED load to be increased, e.g., to rise above a forward voltage of the second LED load. This means that the second LED load can be driven to output light, even if the bus voltage is not sufficiently high to, by itself, drive the second LED load. A headroom for the second LED load is also provided.

In a further embodiment, the power provided at the first LED load is preferably balance with the power required at the second LED load.

In this embodiment, the power loss of the power conversion circuit is optimized. Alternatively, if the power provided by the first LED load is much higher than the power required at the second LED load, the power conversion circuit may need to dissipate the excessive power. This can be done by the power switch of the power conversion circuit or an extra linear switch in the power conversion circuit. Anyway, since the second LED load is powered, the efficiency has been increased than the prior art in which the second LED load is not powered at all.

In some examples, both the first LED load and the second LED load receive the same bus voltage.

This embodiment uses a single bus voltage to power both LED loads. This prevents using separate bus voltage and separate primary power converters for respective LED loads, and reduces the complexity and cost of the lighting circuit.

The inverting circuit may be configured to apply the inverted signal to the second LED load, via the output, so as to control a voltage drop across the second LED load, being a sum of the output voltage and the bus voltage.

In some examples, the primary power supply is adapted to regulate the magnitude of the bus voltage to be higher than a forward voltage of the first LED load but lower than the forward voltage of the second LED load. The advantages of the proposed technique are particularly apparent when the bus voltage is insufficient to drive the second LED load by itself.

In this embodiment, the bus voltage can be chosen as a middle value between the two LED loads, and power loss can be reduced while both LED loads can be driven reliably.

The power conversion circuit may be configured to control the voltage across the first and second LED loads such that: the voltage across the first LED load, being the difference from the bus voltage to the input voltage, approaches a forward voltage of the first LED load; and/or the voltage across the second LED load, being the sum of the bus voltage and the output voltage, approaches a forward voltage of the second LED load.

In this way, the headroom for both LED loads are reduced, and power loss is also reduced.

In an alternative embodiment, the first LED load and the second LED load may be connected in series with respect to the bus.

The primary power supply may be configured to provide a rectified version of an AC mains voltage as the bus voltage to the series connected first and second LED loads in a forward bias direction. The first LED load and the second LED load may be driven by the rectified version of an AC mains voltage gradually and accumulatively, starting from the first LED load, as the rectified version of an AC mains voltage increases. This provides a technique for controlling the operation of the LED loads when driven by an AC mains voltage, which can take into account any fluctuations of the AC mains voltage. This is effectively an known tapped linear driving scheme wherein the LED loads that are driven is depending on the amplitude of the AC mains: in a first phase when the amplitude of the AC mains is higher only than the forward voltage of the first LED load, the first LED load is driven by the AC mains directly but not the second LED load driven by the AC mains directly; in a second phase when the amplitude of the AC mains is higher than the sum of forward voltages of both the first and the second LED loads, a series connection of the first LED load and the second LED load is driven. The forward voltage of the LED loads being actually driven closely match the instantaneous amplitude of the AC mains so that the headroom is constantly regulated low.

In some examples, the input of the converting circuit is coupled to the cathode end of the first LED load; the output of the converting circuitry is coupled to the cathode end of the second LED load; and the power conversion circuit is configured to operate in an active mode when the bus voltage is greater than the forward voltage of the first LED load and less than the sum of the forward voltages of the first and second LED loads, wherein, when operating in the active mode, the inverting circuit is configured to apply the inverted signal, via the output, to the second LED load in a forward bias direction so as to increase the voltage across the second LED load above a forward voltage of the second LED load.

This embodiment effectively utilizes the difference between the bus voltage and the forward voltage of the first LED load during the first phase to drive the second LED load. By comparison, in the known tapped linear driver, this difference in the first phase is dissipated by a linear switch in a power lossy way. Thus the efficiency of this embodiment is high, and the second LED load is driven for more time duration, decreasing non-operating interval and flicker of the second LED load.

The power conversion circuit may be configured to operate in an inactive mode when the bus voltage is greater than the sum of the forward voltages of the first and second LED loads, wherein when operating in the inactive mode, the power conversion circuit is configured to disable the power conversion. In this embodiment, after the AC mains can drive both the first and second LED loads directly, it should do so and there is not necessary to use the power conversion circuit. Thus the switching loss of the power conversion circuit, though already smaller than the power loss of a linear switch, can be prevented.

In a tapped linear driver, there may be three or more taps. The concept of the above embodiment is thus not limited between the first LED load and the second LED load, but can also be applied to the taps after the second tap/second LED load. More specifically, in some examples, the LED lighting circuit further comprises a third LED load connected in series with the first LED load and the second LED load, wherein the first LED load, the second LED load and the third LED load are driven by the voltage bus gradually and accumulatively, starting from the first LED load, as the voltage of the voltage bus increases; and a second converting circuit comprising: a second input connected to the series connection of the first and the second LED loads without going through the third LED load; a second output connected to the series connection of the first, the second and the third LED loads; and a second power conversion circuit connected between the second input and the second output, adapted to receive, at the second input, a power flowing through the first and second LED loads; convert the power; and route the converted power to the third LED load, via the output, to control the power flowing through the third LED load.

In this embodiment, the voltage difference that is dissipated in the known tapped linear driver, when the voltage of the AC mains is between the sum of the forward voltage of the first and the second LED loads and the sum of the forward voltage of the first, the second and the third LED loads, is used/converted in an active manner for driving the third LED load. Power loss is reduced, non-operation interval and flicker of the third LED load are also reduced.

The second power conversion circuit may be configured to operate in an active mode when the bus voltage is both: greater than the sum of the forward voltages of the first LED load and the second LED load; and less than the sum of the forward voltages of the first, second and third LED loads, wherein the second power conversion circuit comprises a second inverting circuit configured to, when the second power conversion circuit is operating in the active mode: invert the polarity of power received at the second input to provide a second inverted signal; and apply the second inverted signal, via the second output, to the third LED load in the forward bias direction so as to increase the voltage difference across the third LED load above a forward voltage of the third LED load.

Preferably, the second inverting circuit is configured to operate in an inactive mode when the bus voltage is smaller than the sum of the forward voltages of the first LED load and the second LED load. The second inverting circuit may also be configured to operate in an/the inactive mode when the bus voltage is greater than the sum of the forward voltage of the first, second and third LED loads.

The second inverting circuit may, when operating in the inactive mode, disable the application of the second inverted signal to the second output.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 schematically illustrates an LED lighting circuit according to a first embodiment;

FIG. 2 illustrates an example of the LED lighting circuit according to the first embodiment;

FIG. 3 illustrates a switched-mode power supply for use in embodiments;

FIG. 4 illustrates an LED lighting circuit according to a second embodiment;

FIG. 5 illustrates converting circuitry for use in embodiments; and

FIG. 6 illustrates a variation of the LED lighting circuit according to the second embodiment.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides an LED lighting circuit. A converting circuitry connects between a first LED load and a second LED load, and controls the power flow through the second LED load by converting a power flow through the first LED load and applying the converted power to the second LED load.

In the context of the present disclosure, when a voltage is applied in a forward bias direction with respect to a (light-emitting) diode, the applied voltage increases the difference V_{DIF} between the voltage at the anode end (V_{AE}) and the voltage (V_{CE}) at the cathode end of that diode, where V_{DF} is V_{AE}−V_{CE}. This increases the voltage difference in the forward bias direction.

Similarly, when a voltage is applied in a reverse bias direction with respect to a diode, the applied voltage decreases the difference V_{DIF} between the voltage at the anode end (V_{AE}) and the voltage (V_{CE}) at the cathode end of that diode, where V_{DF} is V_{AE}−V_{CE}. This decreases the voltage difference in the forward bias direction.

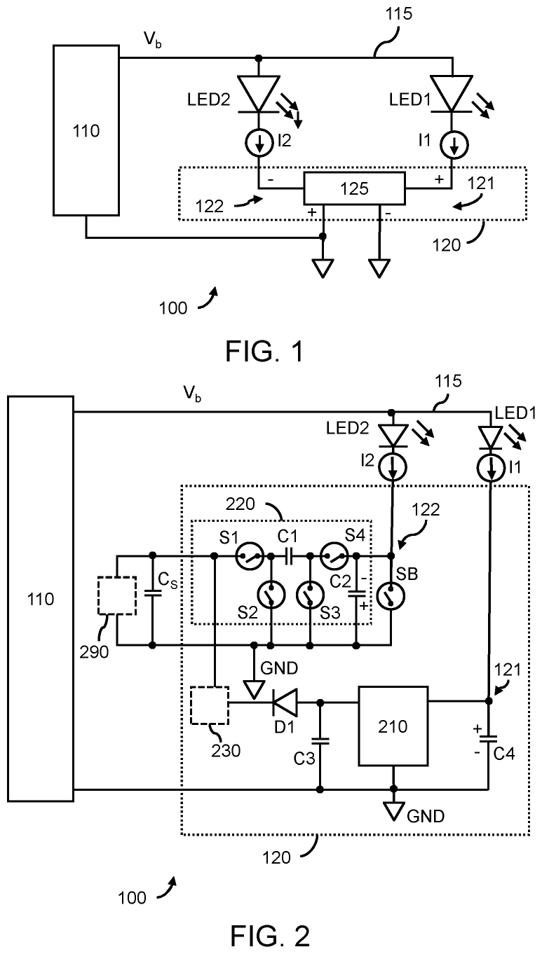

FIG. 1 schematically illustrates an LED lighting circuit 100 according to a first embodiment. The LED lighting circuit 100 comprises a primary power supply 110, a first LED load LED1, a second LED load LED2 and a converting circuit 120.

The primary power supply 110 is configured to output a primary output power on a bus 115. The bus 115 thereby carries a bus voltage V_{b}. The primary power supply 110 may be formed from any suitable power circuitry, e.g., a rectifier, a PFC converter for converting a mains power supply to a bus voltage (e.g., comprising a rectifier, buck converter, boost converter, buck-boost converter or the like) and/or a DC powering system, e.g., comprising one or more batteries or cells.

Preferably the LED lighting circuit 100 comprises a respective linear power supply/current source I1 and I2 for the first LED load and the second LED load, as this helps perform regulation of current through each LED load whilst maintaining a relatively small size and/or material cost. The linear current sources I1 and I2 can be implemented by a transistor, such as a BJT or MOSFET, which are well known in the art.

The first LED load LED1 and the second LED load LED2 are both connected to the bus 115. In the illustrated example, the two LED loads LED1, LED2 are connected in parallel to the bus, e.g., both connected directly to the bus. More specifically, the anode end of each LED load is connected to the bus, such that, for each LED load, the primary output power is able to flow through said LED load when/if the voltage across the LED load exceeds the forward voltage of said LED load.

The converting circuit 120 comprises an input 121. The input 121 and the first LED load LED1 are connected in series with respect to the bus 115. In the illustrated example, the input 121 is coupled to a cathode end of the first LED load LED1.

The converting circuit 120 also comprises an output 122. The output and the second LED load LED2 are connected in series with respect to the bus 115. In the illustrated example, the output 122 is similarly coupled to a cathode end of the second LED load LED2. Note that the input 121 and output 122 can alternatively be placed at the high end/anode end of the respective LED loads.

The converting circuit 120 also comprises a power conversion circuit 125 coupled between the input 121 and the output 122. The power conversion circuit is configured to receive, via the input 121, the power flowing through the first LED load LED1. The power conversion circuit 125 converts this received power and provides the converted power to the second LED load LED2 via the output 122. In this way, the converting circuit is configured to control the power flow through the second LED load using the power flowing through the first LED load.

In a simple example, the power conversion circuit 125 may comprise or be an inverting circuit, such as an inverting switched-mode power supply, configured to invert a polarity of a voltage of power received at the input 121 and provide the inverted power at the output 122. The inverted voltage may be supplied to the cathode end of the second LED load LED2, via the output 122. This increases the voltage across the second LED load LED2 for facilitating driving the second LED load LED2 especially if the bus voltage is not sufficient.

If the power conversion circuit does not have a voltage step-down or step-up function but only the inversion function, the voltage Vₒ at the output 122 of the power conversion circuit (and therefore at the cathode end of the first LED load LED1) will be roughly equal to the bus voltage V_{b} minus the forward voltage V_{F1} of the first LED load LED1, but with opposite polarity. Thus, in this simple example and assuming no/negligible additional losses in inversion, the voltage V_{LED2} across the second LED load LED2 can be roughly calculated by:

$${V}_{LED 2} = {V}_{B} - {V}_{o} \qquad ( 1 )$$

$${V}_{LED 2} = {V}_{B} + ( {V}_{B} - {V}_{F 1} )$$

$${V}_{LED 2} = 2 {V}_{B} - {V}_{F 1}$$

It will therefore be intuitively apparent that the use of an inverting circuit facilitates the driving of a second LED load LED2 having a larger forward voltage than the bus voltage V_{b}.

In this way, the power conversion circuit 125 is adapted to convert an input voltage (V_{B}−V_{F1}) received at the input 121 into an output voltage (V_{F1}−V_{B}) at the output 122. The output 122 is located/position such that the output voltage is effectively superimposed with the power provided by the bus V_{b} to the second LED load. In particular, the output 122 is electrically coupled to a cathode end of the second LED load LED2, i.e., electrically downstream of the second LED load LED2. In this way, the output 122 is connected such that a voltage provided at the output 122 is applied in a forward bias direction of the second LED load LED2.

The power conversion circuit 125 thereby regulates the power flowing through the second LED load, e.g., using an inverting circuit. Preferably, the residual voltage (being the sum of the bus voltage and the output voltage) should approach the forward voltage of the second LED load, so that the power loss is low.

Furthermore, the optional linear current source I2 helps with regulating the current through the second LED load LED2. In examples where the linear current source is present, it is preferable that the voltage drop across the linear current source I2, being the difference between the residual voltage and the forward voltage of the second LED load, is above and as close as possible to the minimum headroom of the linear current source I2. Thus, the linear current source I2 can work stably with a power loss as small as possible. Here “as close as” means the residual voltage is larger than the minimum headroom by not bigger than a second safe margin value such as below 1V.

Thus, the output voltage may be configured such that the voltage drop across the linear current source I2 is larger than the minimum headroom for the linear current source by no more than a second safe margin, e.g., 1V.

A similar principle may apply to the first LED load. In this case, the residual voltage (being the difference of the bus voltage and the input voltage) should approach the forward voltage of the first LED load, so that the power loss is low.

In a variant, the optional linear current source I1 can be included to help with regulating the current. Preferably, the voltage drop across the linear current source I1, being the difference between the residual voltage and the forward voltage of the first LED load, is above and as close as possible to the minimum headroom of the linear current source I1. Thus, the linear current source I1 can work stably with a power loss as small as possible. In this context, “as close as” means the residual voltage is larger than the minimum headroom by not bigger than a first safe margin value such as below 1V.

Thus, the input voltage may be controlled such that the voltage drop across the linear current source I2 is larger than the minimum headroom for the linear current source by no more than a second safe margin, e.g., 1V.

In an example, the power conversion circuit 125 may be adapted to control the input voltage at the input of the power conversion circuit. As illustrated in FIG. 1, this input voltage will be applied in a reverse bias direction of the first LED load (i.e., control of the input voltage will reduce the voltage across the first LED load LED1 in a forward bias direction) and thereby counteracts with the power provided by the bus to the first LED load. This facilitates regulation of the power flowing through the first LED load.

A similar thing happens to the optional linear current source I1 at the first LED load. The voltage drop across the linear current source, being the bus voltage minus the sum of the input voltage and the forward voltage of the first LED load, is a low value as close as the minimum headroom of the linear current source. Thus, the linear current source can work with a power loss as small as possible.

The power conversion circuit may therefore be adapted to control, via the input, the voltage drop across the first LED load and (if present) the linear current source, being a difference from the bus voltage to the input voltage.

Approaches for controlling an input voltage at an input in an active way will be known to the skilled person. Typically, such approaches comprise controlling the effective impedance of a switching circuit, e.g., by modifying the duty cycle of the switching circuit.

In a plausible alternative to the LED lighting circuit 100 according to the first embodiments, the polarity of each LED load is reversed. The applied bus voltage may be a negative voltage to facilitate current flow through each LED load. In this scenario, the input of the power conversion circuit may connect to the cathode end of the first LED load and the output may connect to the anode end of the first LED load. The operation may be otherwise similar/identical.

FIG. 2 illustrates an LED lighting circuit 100 according to the first embodiment having a more complex example of a converting circuit 120.

The converting circuit 120 comprises a switched-mode power supply 210. The switched-mode power supply is configured to convert a power at the input 121 to a converted power. Preferably, the switched-mode power supply comprises a step-up or step-down transformer or converter. Examples of such circuits are well known in the art, and include buck converters, boost converters and/or buck boost converters.

The converting circuit 120 also comprises an inverting circuit 220. The inverting circuit acts to invert the converted power provided by the power conversion circuit 210 and provide the inverted power (in the form of an inverted signal) at the output 122.

In this way, the inverting circuit 220 is adapted to invert the polarity of (converted) power received at the input of the converting circuit to provide an inverted signal; and apply the inverted signal, via the output, to the second LED load, in the forward bias direction, so as to increase the voltage difference across the second LED load.

The illustrated inverting circuit 220 operates using switch-based logic in order to perform an inversion. Thus, the inverting circuit 220 comprises a plurality of switches S1, S2, S3, S4 and a plurality of capacitors that are operated/controlled to perform inversion.

A first switch S1 controllably couples an input to the inverting circuit to a first plate of a first capacitor C1. A second switch S2 controllably couples the first plate of the first capacitor to a reference voltage GND. A third switch S3 controllably couples a second plate (opposite the first plate) of the first capacitor C1 to the reference voltage GND. A fourth switch S4 controllably couples the second plate of the first capacitor C1 to the output node 122. A second capacitor couples the output node 122 to the reference voltage GND to performing smoothing of the voltage at the output node.

In general, a switch is switchable between ON or an “conducting mode” (in which it allows current/power flow therethrough) and OFF or an “blocking mode” (in which it allows no/negligible current/power flow therethrough). Examples of suitable switches are well known to the skilled person, and include FETs such as MOSFETs or other transistors.

To perform inversion, the inverting circuit operates in alternating phases, i.e., sequentially alternates between a first phase and a second phase (which are preferably of equal or near-equal length). During the first phase, the first S1 and third S3 switches are controlled to be in the conducting mode with the second S2 and fourth S4 switches being in the blocking mode. During the second phase, the second S2 and fourth S4 switches are controlled to be in the conducting mode with the first S1 and third S3 switches being in the blocking mode.

Since an inverting circuit is well known for those skilled in the art, more detailed control logic for the inverting circuit 220 is not illustrated for the sake of clarity, but would be readily understand and implemented by the skilled person.

In this way, the inverting circuit is controlled such that the voltage at the output of the inverting circuit is of opposite polarity (but equal magnitude) to the voltage at the input of the inverting circuit.

Other suitable examples of an inverting circuit will be readily apparent to the skilled person.

For improved efficiency, the converting circuit 120 may further comprise a bypass switch SB. The bypass switch SB can controllably bypass the connection between the second LED load LED2 and the output of the inverting circuit. This is advantageous to avoid the need to use the inverting circuit 220 (and/or preceding elements of the converting circuit) when the bus voltage V_{b} exceeds the forward voltage of the second LED load.

In this way, the converting circuit 120 can be controlled to operate in an active mode, in which the inverting circuit provides the inverted signal to the output node (i.e., the converting circuit performs negative voltage compensation) and an inactive mode, in which the output of the inverting circuit is bypassed, such that the second LED load LED2 is driven by the power on the bus 115 only.

The converting circuit 120 may be configured to operate in the active mode when the voltage V_{b} at the voltage bus falls below the forward voltage V_{F2} of the second LED load LED2, i.e., when V_{b}<V_{F2}. The converting circuit 120 may be configured to operate in the inactive mode when the voltage at the voltage bus is at or above the forward voltage V_{F2} of the second LED load LED2, i.e., when V_{F2}>V_{b}. This is useful in the event that the primary power converter is a PFC converter whose output voltage is not a 100% constant voltage but is a constant value component plus a ripple/AC value component.

Further optional features of the converting circuit 120 include a low dropout regulator (LDO) 230 (which performs voltage regulation for a voltage provided to the inverting circuit 220), a third capacitor C3 (which performs smoothing and storage of voltage output by the switched-mode power supply 210), a diode D1 and a fourth capacitor C4 (which performs smoothing and storage of the voltage that has passed through the first LED load LED1.

It is noted that the inverting circuit 220 illustrated in FIG. 2 may be adapted for use as the power conversion circuit in the LED lighting circuit of FIG. 1. Thus, the switched-mode power supply 210 illustrated in FIG. 2 may be omitted in some examples (with the inverting circuit acting as the power conversion circuit).

Another optional feature illustrated in FIG. 2 is an auxiliary component 290. The auxiliary component may be any component of the LED lighting circuitry (or nearby circuitry) that needs to be powered, such as a controller for the LED lighting circuitry, e.g., an MCU or sensing components.

The converting circuit 120 may be configured to produce a power supply for the auxiliary component 290. In the illustrated example, this is achieved by the auxiliary component drawing power from the switched-mode power supply 210 of the converting circuit 120. In particular, the switched-mode power supply 210 charges a storage capacitor Cs that stores power to be drawn by the auxiliary component. This provides a supplementary function to the converting circuit 120.

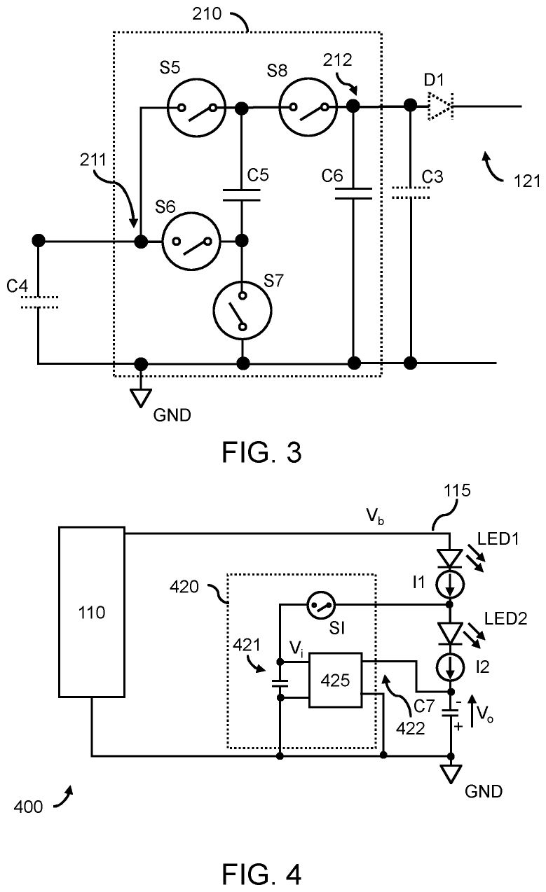

FIG. 3 illustrates an example switched-mode power supply 210 for use in the previously described converting circuit. A portion of the surrounding circuitry is also illustrated for improved contextual understanding.

The switched mode power supply comprises a plurality of switches S5, S6, S7, S8 and capacitors C5, C6 for performing power conversion of a received signal (e.g., at an input 121). In particular, the illustrated switched-mode power supply is configured to perform a voltage step-up conversion, such that the voltage at an output 212 of the switched-mode power supply is larger (e.g., twice) the voltage at the input of the switched-mode power supply.

In some examples, capacitor C6 can be omitted, and capacitor C3 may form part of the switched-mode power supply 210.

A fifth switch S5 controllably couples an input 211 to the switched-mode power supply to a first plate of a fifth capacitor C5. A sixth switch S6 controllably couples the input 211 to the switched-mode power supply to a second plate (opposite to the first plate) of the fifth capacitor. A seventh switch S7 controllably couples the second plate of the fifth capacitor C5 to a ground/reference voltage GND. An eighth switch S8 controllably couples the first plate of the fifth capacitor C5 to an output 212 of the switched-mode power supply.

Control of the switches S5, S6, S7, S8, of the switched-mode power supply is performed during the same phases as control of the switches of the inverting circuit.

In particular, during a first phase, the fifth S5 and seventh S7 switches are controlled to be in the conducting mode with the sixth S6 and eighth S8 switches being in the blocking mode. During the second phase, the sixth S6 and eighth S8 switches are controlled to be in the conducting mode with the fifth S5 and seventh S7 switches being in the blocking mode.

In this way, during the first phase, the fifth capacitor C5 is connected in parallel with the input 211, and charged to the voltage at the input: V(C5)=V(211). During the second phase, the fifth capacitor is connected in series with the input 211, such that the voltage at the output 211 of the switched-mode power supply is the sum of the voltage at the input and the voltage across the fifth capacitor: V(212)=V(C5)+V(211). As the voltage across the fifth capacitor is charged to be equal to the voltage at the input, this effectively causes the voltage at the output to be charged to twice the voltage at the input: V(212)=2·V(211). The sixth capacitor C6 performs a smoothing operation to smooth out the effects of the switching.

Although not essential, in some examples, when the converting circuit 120 is controlled to operate in the inactive mode, the switched-mode power supply is controlled such that the sixth and seventh switches are controlled to be in the conducting mode (i.e., to bypass the remainder of the converting switched-mode power supply). This increases the efficiency of the overall LED lighting circuit.

It will be appreciated that the power conversion circuit of the first embodiment may also be adapted to control the input voltage at the input of the power conversion circuit.

FIG. 3 implements the switched-mode power supply 210 using a switched capacitor converter. The advantage lies in its small/compact size. Alternatively, the switched-mode power supply 210 can be implemented by an inductor-based switched converter such as a boost converter, etc.

In the above embodiment, the first and the second LED loads are in parallel connection. This is not the only implementation.

FIG. 4 schematically illustrates an LED lighting circuit 400 according to a second embodiment. The LED lighting circuit 400 comprises a primary power supply 110, a first LED load LED1, a second LED load LED2 and a converting circuit 420. The primary power supply 110 could be a rectifier that rectifies an AC input voltage.

The main difference between the present LED lighting circuit 400 and the previously described LED lighting circuit is that the first and second LED loads LED1, LED2 are connected in series (rather than in parallel). In this way, the first LED load LED1 and the second LED load LED2 are configured such that, as the magnitude of the voltage bus increases, so the number of LED loads that are driven by the voltage of the voltage bus would gradually and accumulatively increase starting from the first LED load LED1.

The converting circuit comprises an input 421 connected to the cathode end of the first LED load LED1 and the ground, and an output connected to the cathode end of the second LED load LED2 and the ground. Thus, the input is connected between the first LED load LED1 and the bus 115, and the output is connected between the second LED load LED2 and the bus 115.

The converting circuit 420 also comprises a power conversion circuit 425 coupled between the input 421 and the output 422. The power conversion circuit 425 is configured to receive, via the input 421, the power flowing through the first LED load LED1. The power conversion circuit 425 is able to convert this received power and provide the converted power to the second LED load LED2 via the output 422. In this way, the converting circuit is configured to control the power flow through the second LED load using the power flowing through the first LED load.

Like the first embodiment, in a simple example, the power conversion circuit 425 may comprise or be an inverting circuit, such as an inverting switched-mode power supply, configured to invert a polarity of a voltage of power received at the input 421 and provide the inverted power at the output 422. The inverted voltage may be supplied to the cathode end of the second LED load LED2, via the output 422. This increases the voltage across the second LED load LED2.

The voltage Vᵢ at the input 421 to of the power conversion circuit will be roughly equal to the bus voltage V_{b} minus the forward voltage V_{F1} of the first LED load LED1: Vᵢ=V_{B}−V_{F1}. The voltage Vₒ at the output will be equal to the inversion (i.e., opposite polarity) of the input voltage Vᵢ, i.e., Vₒ=−Vᵢ. Thus, equation (1) can still hold true for the simple example of the power conversion circuit for the second embodiment. By comparison, in a traditional tapped linear driver, the difference between the bus voltage V_{b} and the forward voltage V_{F1} of the first LED load LED1 is usually dissipated on a linear current source which causes power loss.

The power conversion circuit 425 may be deactivated responsive to the bus voltage V_{b} exceeding the sum of forward voltages of the first and second LED loads. Deactivating the power conversion circuit 425 may prevent the power conversion circuit 425 from converting the power at the input 421 and/or providing the same to the output 422.

This can be achieved using an isolating switch SI connected in series with the power conversion circuit 425. The isolation switch may form part of the converting circuit 420.

If the bus voltage V_{b} is sufficiently large (i.e., when V_{b}≥V_{F1}+V_{F2}), such that it is greater than or equal to the sum of the forward voltages of the first and second LED loads, then the isolation switch can be controlled to be in a blocking mode to disconnect the power conversion circuit from the input 421. Also the capacitor C7 can be bypassed by a switch (not shown). In this way, the primary output power (i.e., the bus voltage) drives the first and second LED loads by itself like the traditional tapped linear driver.

If the bus voltage V_{b} is insufficiently large (i.e., when V_{b}<V_{F1}+V_{F2}), such that it is smaller than the sum of the forward voltages of the first and second LED loads, then the isolation switch can be controlled to be in a conductive mode. In this way, the power conversion circuit is activated, as it provides a converted power to the output 422 (when current flows through the first LED load LED1) as mentioned above.

In some examples, if the bus voltage V_{b} is less than a minimum voltage Vₘᵢₙ, then the power conversion circuit 425 will be unable to supply an output voltage Vₒ, at the output 422, that results in the voltage across the second LED load LED2 exceeding the forward voltage V_{F2} of the second LED load LED2. For improved efficiency, the power conversion circuit 425 may be isolated in this scenario and/or the power conversion circuit 425 may be bypassed (e.g., using a separate bypass switch (not shown)), and even alternatively the power conversion circuit 425 can work in a fully pass through mode to connect the first LED load LED1 to the ground without converting. The minimum voltage Vₘᵢₙ can be defined using the following equation:

$${V}_{min} = \frac{{V}_{F 2}}{2} + {V}_{F 1} \qquad ( 2 )$$

Thus, in some examples, the power conversion circuit is activated, so as to provide an output voltage Vₒ, only when the bus voltage V_{b} lies between the minimum voltage Vₘᵢₙ and the sum of the forward voltages of the first and second LED loads (i.e., Vₘᵢₙ≤V_{b}≤V_{F1}+V_{F2}).

Appropriate mechanisms for monitoring a voltage of a voltage bus and effecting control over the operation of switches responsive thereto are well known in the art.

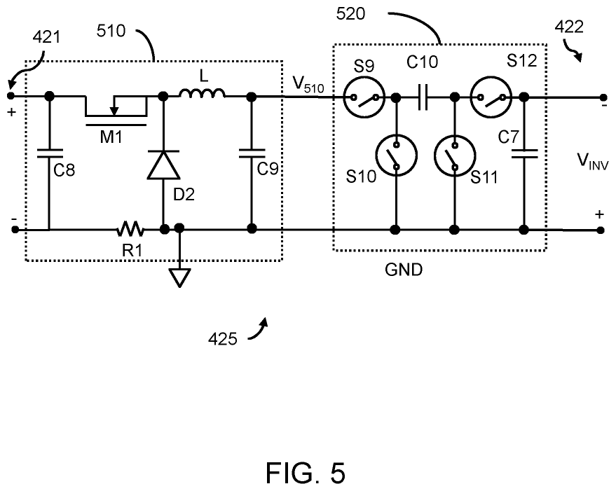

FIG. 5 illustrates an alternative converting circuit 400 for use with the second embodiment. The converting circuit 400 comprises a switched-mode power supply 510 (specifically, a buck converter) and an inverting circuit 520.

Generally, the switched-mode-power supply controls a magnitude of the voltage provided to the output 422 and the inverting circuit inverts or changes the polarity of the voltage such that it has opposite polarity to the voltage at the input 421.

The switched-mode power supply comprises an input C8 and output C9 capacitor, a MOSFET M1, an inductor L, a freewheeling diode D2 and a resistor R1 (which may be omitted in some embodiments). Approaches for operating and controlling such a switched-mode power supply are well established in the art, and are not repeated for the sake of conciseness. The switched-mode power supply is not restricted to the illustrated structure, and any suitable configuration may be used instead. For example, a boost converter can be used instead.

In some examples, the switch mode power supply is operated as an input constant current and output constant voltage converter. The resistor R1 may act as a sensing resistor. The input current is sensed using the sensing resistor and compared with a reference voltage. Based on a result of the comparison, the operation of the MOSFET M1 may be controlled to make input current constant control. CCM control can therefore be adopted, the average current is determined by given input current value.

By adjusting the duty cycle of the switching of M1, the effective input impedance of the switched-mode power supply can be changed, and thus the voltage at the input, which is in series with the first LED load and the bus voltage, can be effectively tuned to make the residual voltage approach the forward voltage of the first LED load as mentioned above.

The duty cycle of the switching of M1 can also be adjusted to ensure or provide a desired voltage V₅₁₀ at the output of the switched-mode power supply, which techniques are well known in the art. In particular, the voltage V₅₁₀ may be selected such that the residual voltage, being the sum of the bus voltage and the output voltage, approaches the forward voltage of the second LED load, such that power loss is reduced.

Thus, in some examples, the voltage V₅₁₀ may be selected based on the following equation:

$${V}_{510} = {V}_{F 1} + {V}_{F 2} - {V}_{b} \qquad ( 3 )$$

The voltage V₅₁₀ is then inverted by the inverting circuit 520 to produce an inverted signal V_{INV} at the output 422. The voltage of the inverted signal is chosen such that the voltage across the first and second LED loads is greater than or equal to a forward voltage of the first and second LED loads. If the voltage V₅₁₀ is chosen as set out in equation (3), the headroom is reduced.

In some examples, a linear current source I2 is connected in series with the second LED load (e.g., for controlling current flow as previously explained, e.g., to facilitate constant current driving). In this scenario, the headroom for the linear current source I2 (e.g., voltage across) is preferably larger but as close as possible to the minimum headroom of this linear current source so as to keep it operating stably at minimum power loss. This improves efficiency of the LED lighting circuit. Similar as the previous embodiment, a linear current source I1 is also provided to the first LED load LED1.

It will be appreciated that the voltage across the linear current source will be equal to the difference between the residual voltage and the forward voltage of the second LED load (i.e., V_{b}+Vₒ−V_{F1}). To facilitate constant current driving, in example where the linear current source is present, the voltage V₅₁₀ may be selected based on the following equation:

$${V}_{510} = {V}_{F 1} + {V}_{F 2} - {V}_{b} + {V}_{min h} \qquad ( 4 )$$

where Vₘᵢₙₕ is a value larger than, but as close as possible to, the minimum headroom of this linear current source so as to keep it operating stably at minimum power loss. Here, the value of Vₘᵢₙₕ may be equal a value larger than the minimum headroom plus a safety margin value (e.g., minimum headroom+1V).

The inverting circuit 520 comprises a plurality of switches S9, S10, S11, S12 and capacitors C7, C10. The structure and operation of the inverting circuit may be identical to the inverting circuit previously described with reference to FIG. 2, and is not repeated for the sake of conciseness.

It will be clear that the switched-mode power supply 510 receives an input voltage at the input 421, and performs a step-down function (e.g., a voltage step down function)—as it operates as a buck converter. The stepped-down voltage is inverted by the inverting circuit 520 to produce an inverted signal at the output 422.

It was previously explained, with reference to FIG. 4, how the converting circuit may comprise an isolating switch. For the converting circuit 400 illustrated in FIG. 5, the MOSFET M1 of the switched-mode power supply 510 may perform the function of the isolating switch (e.g., so that it is held permanently in a blocking mode when there is a desire to isolate the converting circuit). It will be appreciated that, when the converting circuit is in an active mode, control of the MOSFET M1 follows a standard buck converter function (e.g., switches on and off according to a desired pattern to attain a desired voltage output).

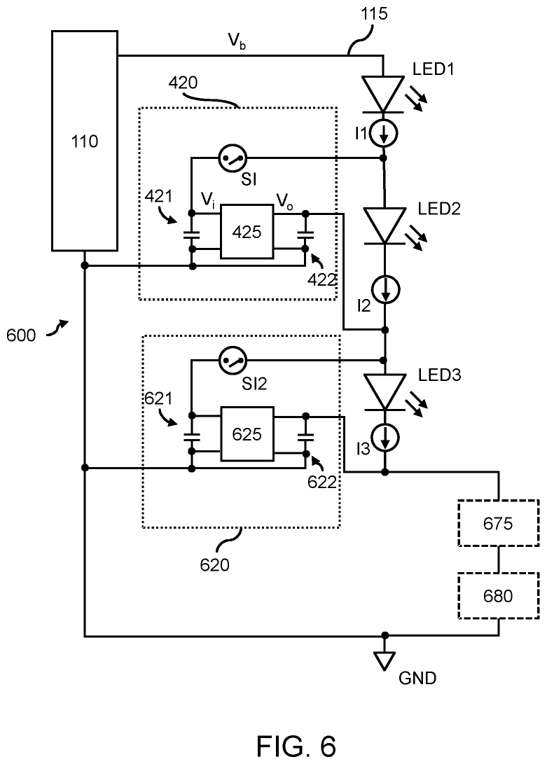

FIG. 6 illustrates a modified version of the LED lighting circuit 600 according to the second embodiment (and previously described with reference to FIG. 4).

The LED lighting circuit 600 differs from the previously described LED lighting circuit by further comprising a third LED load LED3. The third LED load LED 3 is connected in series with the first LED1 and second LED2 LED loads.

The LED lighting circuit 600 also comprises a second converting circuit 620.

The second converting circuit 620 comprises a second input 621 connected to the series connection of the first LED1 and the second LED LED2 loads without going through (i.e., being located electrically downstream of) the third LED load. Thus, the second input is connected at a point that lies between a cathode end of the second LED load and an anode end of the third LED node, e.g., is connected to the cathode end of the second LED load.

The second converting circuit 620 also comprises a second output capacitor 622 connected to the series connection of the first, the second and the third LED loads. Thus, the second output is connected electrically downstream of the third LED load LED3, e.g., to a cathode end of the third LED load LED3.

The second converting circuit 620 also comprises a second power conversion circuit 625 connected between the second input 621 and the second output 623. The operation and structure of the second power conversion circuit 625 is similar to the operation of the power conversion circuit 425, and is not repeated in detail for the sake of conciseness.

In general, the second power conversion circuit 625 is configured to receive, at the second input, a power flowing through the first and second LED loads; convert the power; and route the converted power to the third LED load, via the second output, to control the power flowing through the third LED load.

The second power conversion circuit 625 is preferably operable in an active mode and an inactive mode. When operating in the active mode, the power conversion circuit 625 provides a converted power to the second output. When operating in the inactive mode, the power conversion circuit 625 does not provide the converted power to the second output (e.g., the power conversion circuit is bypassed and/or isolated, e.g., using a second isolation switch SI2).

Preferably, the second power conversion circuit comprises a second inverting circuit configured to invert the polarity of power received at the second input to provide a second inverted signal. The second inverted signal is provided at the second output to increase the voltage difference across the third LED load (e.g., to drive the third LED load).

Thus, in preferred examples, the second power conversion circuit operates in the active mode only when the bus voltage is greater than the sum of the forward voltages of the first LED load and the second LED load, i.e., V_{b}>V_{F1}+V_{F2}. In some further examples, the second power conversion circuit operates in the active mode only when the bus voltage is both: greater than the sum of the forward voltages of the first LED load and the second LED load; and less than the sum of the forward voltages of the first, second and third LED loads, i.e., V_{F1}+V_{F2}<V_{b}≤V_{F1}+V_{F2}+V_{F3}.

Otherwise, the second power conversion circuit may operate in an inactive mode, e.g., be bypassed (preferable when V_{b}<V_{F1}+V_{F2}) or isolated (preferable when V_{b}>V_{F1}+V_{F2}+V_{F3}).

Thus, if the bus voltage V_{b} is sufficiently large (i.e., when V_{b}≥V_{F1}+V_{F2}+V_{F3}), such that it is greater than or equal to the sum of the forward voltages of the first, second and third LED loads, then the second isolation switch SI2 can be controlled to be in a blocking mode to disconnect the power conversion circuit from the second input 621. In this way, the primary output power (i.e., the bus voltage) drives the first, second and third LED loads by itself.

If the bus voltage V_{b} is insufficiently large (i.e., when V_{F1}+V_{F2}<V_{b}<V_{F1}+V_{F2}+V_{F3}), such that it is larger than the sum of the forward voltages of the first and second LED loads but smaller than the sum of the forward voltages of the first, second and third LED loads, then the second isolation switch SI2 can be controlled to be in a conductive mode. In this way, the second power conversion circuit is activated, as it provides a converted power to the second output 622 (when current flows through the first LED load LED1). A linear current source I3 is provided in series to the third LED load for regulating the current from the voltage provided by the second power conversion circuit.

In some examples, if the bus voltage V_{b} is less than a second minimum voltage Vₘᵢₙ₂, then the second power conversion circuit 625 will be unable to supply a second output voltage at the second output 622, that results in the voltage across the third LED load LED3 exceeding the forward voltage V_{F3} of the third LED load LED3. For improved efficiency, the second power conversion circuit 625 may be isolated in this scenario and/or the second power conversion circuit may be bypassed (e.g., using a separate bypass switch (not shown)). The second minimum voltage Vₘᵢₙ₂ can be defined using the following equation:

$${V}_{min 2} = {V}_{F 1} + {V}_{F 2} + \frac{{V}_{F 3}}{2} \qquad ( 5 )$$

Thus, in some examples, the second power conversion circuit is activated, so as to provide a second output voltage Vₒ, only when the bus voltage V_{b} lies between the second minimum voltage Vₘᵢₙ₂ and the sum of the forward voltages of the first, second and third LED loads (i.e., Vₘᵢₙ₂≤V_{b}≤V_{F1}+V_{F2}+V_{F2}).

FIG. 6 illustrates further optional features of the LED lighting circuit 600. In particular, the LED lighting circuit 600 may comprise a further power conversion circuit 675 and an auxiliary component 680. The further power conversion circuit may comprise a power converter for driving or powering the auxiliary component. The further power conversion circuit thereby makes use of power carried by the bus 115 that remains unused by the LED loads. This increases an efficiency of the overall LED lighting circuit 600, in that power wastage is reduced.

The further power conversion circuit 675 could, for instance, be a linear current source or a traditional SMIPS converter (such as a buck). The further power conversion circuit thereby provides energy to the auxiliary component.

The auxiliary component 680 may, for instance, be a controller or processor for the LED lighting circuit (e.g., the component that controls the operation of any switches in the LED lighting circuit).

FIGS. 4 and 6 illustrate scenarios in which different numbers of LED loads are connected in series, with different numbers of converting circuits being used to control power flow through different LED loads. More LED loads and the corresponding converting circuits can be added. This can be generalized such that there is proposed a concept of an LED lighting circuit comprising N LED loads (connected in series to a bus) with N−1 converting circuits.

Each i-th converting circuit is connected in parallel with the i+1th LED load. Each converting circuit may be configured to only be activated (e.g., to provide an inverted signal at its corresponding output) when the voltage V_{b} of the voltage bus is between an i-th minimum voltage Vₘᵢₙ₍ᵢ₎ and an i-th maximum voltage Vₘₐₓ₍ᵢ₎. Otherwise, the i-th converting circuit may be bypassed (preferably when the voltage V_{b} is below the i-th minimum voltage) or isolated (preferably when the voltage V_{b} is above the i-th maximum voltage. The value of the i-th minimum voltage Vₘᵢₙ₍ᵢ₎ and the i-th maximum voltage Vₘₐₓ₍ᵢ₎ may be governed by the following equations:

$${V}_{min ( i )} = {\sum }_{j = 1}^{i} {V}_{f ( j )} + \frac{{V}_{F ( i + 1 )}}{2} \qquad ( 6 )$$

$${V}_{max ( i )} = {\sum }_{j = 1}^{i + 1} {V}_{f ( j )} \qquad ( 7 )$$

where V_{F(j)} is the forward voltage of the jth LED load and V_{F(i+1)} is the forward voltage of the i+1th LED load.

This provides a fully controllably and configurable LED lighting circuit.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The innovation can be used for indoor and outdoor lighting, as well as automotive lighting.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A LED lighting circuit comprising:
a primary power supply configured to output a primary output power on a bus such that the bus carries a bus voltage;
a first LED load connected to the bus and with a forward voltage less than the bus voltage;
a second LED load connected to the bus and with a forward voltage higher than the bus voltage;
wherein the LED driving arrangement further comprises a converting circuit comprising:
an input, wherein the first LED load and the input are connected in series across the bus;
an output, wherein the second LED load and the output are connected in series across the bus, wherein a series connection of the second LED load and the output is in parallel with the series connection of the first LED load and the input; and
a power conversion circuit connected between the input and the output and adapted to:
receive, at the input, a power flowing through the first LED load;
convert the power; and
route the converted power to the second LED load via the output, to control the power flowing through the second LED load.

2. The LED lighting circuit of claim 1, wherein the power conversion circuit is adapted to:
convert an input voltage received at the input into an output voltage at the output; and
control the output voltage at the output, which output voltage is applied in a forward bias direction of the second LED load so as to be superimposed with the power provided by the bus to the second LED load and regulate a power flowing through the second LED load.

3. The LED lighting circuit of claim 2, wherein the power conversion circuit is adapted to control the input voltage at the input which input voltage is applied in a reverse bias direction of the first LED load and adapted to counteract with the power provided by the bus to the first LED load, so as to regulate a power flowing through the first LED loads.

4. The LED lighting circuit of claim 1, wherein the power conversion circuit is adapted to:
control, via the input, a first residual voltage, being a difference between the bus voltage and the voltage at the input, to approach the forward voltage of the first LED load, and
control, via the output, a second residual voltage, including the voltage at the output, to approach the forward voltage of the second LED load.

5. The LED lighting circuit of claim 4, further comprising:
a first linear current source connected between the first LED load, the input and the bus and with a first minimum voltage headroom, and
a second linear current source connected between the second LED load, the output and the bus and with a second minimum voltage headroom;
wherein the power conversion circuit is configured to:
control the voltage at the input such that a first voltage difference, between the first residual voltage and the forward voltage of the first LED load, is applied on the first linear current source and is no less than but as close as possible to the first minimum voltage headroom; and
control the voltage at the output such that a second voltage difference, between the second residual voltage and the forward voltage of the second LED load, is applied on the second linear current source and is no less than but as close as possible to the first minimum voltage headroom.

6. The LED lighting circuit of claim 4, wherein the converting circuit comprises an inverting circuit adapted to:
invert the polarity of power received at the input of the converting circuit to provide an inverted signal; and
apply the inverted signal, via the output, to the second LED load, in the forward bias direction, so as to increase the voltage difference across the second LED load; and
the power provided at the first LED load is preferably balanced with the power required at the second LED load.

7. The LED lighting circuit of claim 4, wherein the converting circuit further comprises a switched-mode power supply connected between the input and the inverting circuit and adapted for stepping up or down the voltage of the power received at the input.

8. The LED lighting circuit of claim 1, wherein both the first LED load and the second LED load are adapted to be powered substantially by the same bus voltage.

9. The LED lighting circuit of claim 8, wherein the inverting circuit is configured to apply the inverted signal to the second LED load, via the output, so as to control the second residual voltage across the second LED load, being a sum of the output voltage and the bus voltage.

10. The LED lighting circuit of claim 8, wherein the primary power supply is adapted to regulate the magnitude of the bus voltage to be higher than a forward voltage of the first LED load but lower than the forward voltage of the second LED load.

11. A luminaire comprising the LED lighting circuit of claim 1.
